(19) United States
(12) Patent Application Publication
(10) Pub. No.: US 2024/0417633 A1
(43) Pub. Date: Dec. 19, 2024

(54) PROCESS FOR DEBOTTLENECKING FCC WET GAS COMPRESSOR AND GAS PLANT

(71) Applicants: Madhavendra Kapkoti, Delhi (IN); Gautham Krishnaiah, Houston, TX (US); Rahul Radhakrishna Pillai, Manvel, TX (US); Matthew James Griffiths, Arlington Heights, IL (US); Rajeev Ranjan, Delhi (IN)

(72) Inventors: Madhavendra Kapkoti, Delhi (IN); Gautham Krishnaiah, Houston, TX (US); Rahul Radhakrishna Pillai, Manvel, TX (US); Matthew James Griffiths, Arlington Heights, IL (US); Rajeev Ranjan, Delhi (IN)

(73) Assignee: Kellogg Brown & Root LLC, Houston, TX (US)

(21) Appl. No.: 18/741,116

(22) Filed: Jun. 12, 2024

Related U.S. Application Data
(60) Provisional application No. 63/508,456, filed on Jun. 15, 2023.

(51) Int. Cl. C10G 70/04; C10G 55/08

(52) U.S. Cl. CPC C10G 70/045; C10G 55/08; C10G 70/041; C10G 2300/4056; C10G 2400/26

(57) ABSTRACT

In a Fluid Catalytic Cracker (FCC) unit being operated in petrochemical mode that has an increased dry gas and LPG production that creates a bottleneck in product flow, a method for full or partial separation of light gas components from a wet gas compressor suction stream and routing it directly to an untreated fuel gas header using a parallel system to an existing wet gas compressor, which parallel system includes an auxiliary compressor and a membrane separation system.

### CROSS REFERENCE TO RELATED APPLICATION

This application claims priority to U.S. Provisional patent application having Ser. No. 63/508,456 filed on Jun. 15, 2023 which is incorporated by reference herein.

### TECHNICAL FIELD

The present invention relates to systems and methods for processing hydrocarbons in a Fluid Catalytic Cracker (FCC) unit, and more particularly relates to systems and methods for systems and methods for processing hydrocarbons in a FCC unit operated in petrochemical mode as contrasted with being operated in gasoline/diesel maximization mode.

### BACKGROUND

The fluid catalytic cracking unit (FCC) has long been a key producer of high-octane gasoline at the heart of a refinery. However, there is a declining trend in the global demand for motor fuels together with a sustained growth in demand for petrochemicals. Existing FCC units that are designed to maximize motor fuels (i.e., gasoline and light cycle oil) can be operated to maximize petrochemical feedstocks (e.g., propylene and ethylene) by operational adjustments, minor technology upgrades, and/or catalyst reformulation.

FCC units that are designed to maximize gasoline/diesel operate the riser typically in the range of about 480° C.-520° C. Under these conditions, low riser outlet temperatures, the dry gas and liquified petroleum gas (LPG) production is low. The product recovery system (Wet Gas Compressor and Gas Plant) is designed for these product requirements.

An existing FCC unit, originally designed to maximize fuels production can be operated in a petrochemical mode (i.e., maximizing ethylene and propylene), by increasing operating severity. This requires increasing the riser outlet temperature (in one non-limiting instance from about to 550° C.-650° C.), using shape selective zeolites such as ZSM-5 in the catalyst formulation (0%-100%), and making hardware modifications. This results in a significant increase in dry gas and LPG production from the FCC reactor. However, the existing wet gas compressor and gas concentration section equipment may not be capable of handling such increased hydrocarbons loads, and thus a bottleneck would result.

It would be desirable to be able to an operate an existing FCC unit in a petrochemical mode while avoiding such a bottleneck in hydrocarbon loads by making minimal capital investment.

### SUMMARY

There is provided, in one non-limiting embodiment, a Fluid Catalytic Cracker (FCC) unit having a wet gas compressor (WGC) comprising suction, a C3-C4/naphtha fractionation unit, and a gas plant section comprising an effluent feeding a fuel gas system. The FCC unit is characterized by, in parallel to the WGC, an auxiliary compressor comprising a FCC slip stream from the WGC suction and a membrane system receiving compressed FCC wet gas from the auxiliary compressor, where the membrane system includes a separated relatively lighter hydrocarbon component effluent stream in fluid communication with the C3-C4/naphtha fractionation unit and a separated relatively heavier hydrocarbon component effluent stream in fluid communication with an untreated fuel gas system.

Further there is provided a method for operating a FCC unit in petrochemical mode, where the method includes feeding dry gas and LPG from a FCC fractionator to a WGC, withdrawing a slip stream from the feed to the WGC and supplying it to an auxiliary compressor and membrane separation system, which auxiliary compressor and membrane separation system is parallel to the WGC, compressing the slip stream in the auxiliary compressor to produce a compressed stream, feeding the compressed stream to a membrane system comprising a membrane, separating the compressed stream via the membrane into a relatively lighter hydrocarbon component effluent stream and a relatively heavier hydrocarbon component effluent stream, transporting the relatively lighter hydrocarbon component effluent stream to a C3-C4/naphtha fractionation unit, and transporting the relatively heavier hydrocarbon component effluent stream to an untreated fuel gas system which in turn feeds a treatment section.

### BRIEF DESCRIPTION OF THE DRAWING

FIG. 1 is a non-limiting, schematic block flow diagram of a system and method for debottlenecking a FCC wet gas compressor and gas plant when they are operated in petrochemical mode.

It will be appreciated that the drawings are schematic illustrations, and that the invention is not limited to the design, proportions, or specific equipment shown in the drawings.

### DETAILED DESCRIPTION

Currently, most refineries that switch to operating into a petrochemical mode install a parallel gas plant, revamp the existing wet gas compressor, and/or install a bigger wet gas compressor depending upon the increase in hydrocarbon load from the reactor. However, all of these approaches require significant capital investment.

It has been discovered that when a FCC wet gas compressor and gas plant are operated in petrochemical mode to maximize the production of ethylene and propylene, that the increase in dry gas and LPG produced can be debottlenecked, avoided, or otherwise resolved by full or partial separation of the light gas components from the wet gas compressor (WGC) suction stream and routing them directly to an untreated fuel gas header. This can be accomplished by providing in parallel to the WGC an auxiliary compressor and a membrane system.

The installation of a parallel gas plant and/or bigger wet gas compressor to handle additional LPG and dry gas volumetric flow rate is extremely capital intensive. Implementation of the method and system described herein will help the existing FCC units to adapt to the changes expected in the marketplace and operate in high severity conditions and maximize the propylene and ethylene yields with minimal capital investment. That is, the FCC reactor can be operated in petrochemical mode to generate additional C3/C4 and naphtha as compared to the FCC unit being operated in gasoline/diesel maximization mode, yet in the absence of a parallel gas plant.

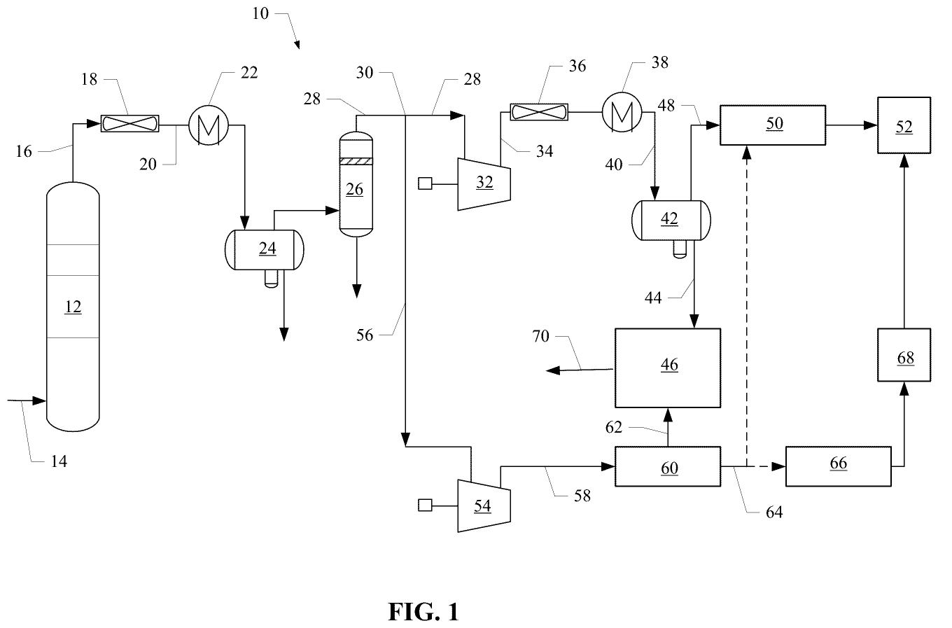

More specifically, the invention is described with respect to FIG. 1 in one non-limiting embodiment, where 10 refers to the overall Fluid Catalytic Cracker (FCC) unit where FCC main fractionator column 12 receives hydrocarbon feed 14 from an FCC reactor. FCC main fractionator column 12 generates main fractionator overhead gasses 16 which are condensed in main fractionator overhead air condenser 18. Condensed gases 20 are routed to main fractionator overhead trim condenser 22 and in turn to overhead (O/H) receiver 24, the product of which is transported to KO drum (WGC suction knockout drum) 26. This front end indicates the absence of “free water” in the gas stream 28 and ahead of the stream split 30 in the system 10.

Conventionally, the gas 28 in the FCC unit 10 is directed to a wet gas compressor (WGC) 32 comprising suction which feeds compressed gas 34 to a high-pressure separator air condenser 36 and high pressure separator trim condenser 38 before condensed, compressed gas 40 is separated at a high pressure separator drum 42. C3/C4 LPG 44 separated in separator drum goes to C3-C4/naphtha fractionation unit 46. Separated hydrocarbons 48 are routed to gas plant section 50 and then fuel gas system 52.

The new system and method include an auxiliary compressor 54 and membrane system 60 installed in parallel to the existing WGC 32.

This new parallel system takes a slip stream 56 from the WGC suction 28 at the split 30. In one non-limiting embodiment, the slip stream 56 is from about 20 independently to about 25 volume % (in a non-limiting example) of the total volume of WGC suction 28. In another non-limiting embodiment, the slip stream varies from about 10% independently to about 50% of the total volume of WGC based on the technical and economic constraints. As used herein with respect to a range, the term “independently” means that any end point may be used together with any other endpoint to give a suitable alternative range. For instance, the slip stream can suitable be from about 10 to about 20 vol % of the total volume of WGC suction 28.

The slip stream 56 is compressed in small capacity auxiliary compressor 54. Auxiliary compressor 54 is simply relatively smaller than WGC 32, the auxiliary compressor volumetric capacity will be about 25% of existing wet gas compressor capacity. The compressed gas 58 is routed to membrane system 60 which will selectively separate the lighter hydrocarbon components (permeate) 64 from the FCC wet gas stream 58. The separated permeate 64 is routed to the FCC gas plant 50, and/or to an untreated fuel gas system 66. The effluent from the untreated fuel gas system 66 may then be sent on to an existing fuel gas treatment section 68 and then to fuel gas system 52 mentioned earlier.

Non-limiting examples of suitable membranes for use in the membrane system 60 include, but are not necessarily limited to, hydrocarbon selective membranes. Other membrane types cannot provide desired separation of the streams necessary for this invention. Suitable hydrocarbon selective membranes are commercially available and suitable examples include, but are not necessarily limited to glassy polymers, rubbery polymers, and hybrid matrix membranes. Suitable glassy polymers include, but are not necessarily limited to, polysulfone, polyimide, polyimide/polyaramid, polyimide/polysulfone, cellulose acetate, ethyl cellulose, poly (phenylene oxide), perfluoro polymer, tetrabromo polycarbonate, and combinations thereof. Suitable rubbery polymers include, but are not necessarily limited to, poly (ether-b-amide) copolymer, polysiloxane, and combinations thereof. Suitable membrane module types include, but are not necessarily limited to, hollow fiber, spiral wound, plate and frame, and combinations thereof. Manufacturers of these membranes include, but are not necessarily limited to Air Products, Air Liquide, Ube, Parker-Hannifin, Evonik, Praxair, Grasys, UOP, Kvaerner, W.R. Grace, MTR, Fuji Film, Schlumberger (Natco), Aquila, ABB/MTR, Generon (MG), and GKSS.

The C3-C4 LPG and naphtha components (retentate) 62 separated from the membrane can be directly routed to the existing debutanizer system, that is C3-C4/naphtha fractionation unit 46, bypassing the gas concentration section. Hence, additional dry gas, C3/C4 LPG generation from FCC reactor can be handled in existing system without installation of a parallel gas plant resulting in significant capital cost avoidance while debottlenecking the FCC unit when operated in petrochemical mode. In other words, debottlenecking can be accomplished in the absence of a parallel gas plant.

In examples, the C3-C4/naphtha fractionation unit 46 may include a hot high pressure separator, separating condensable gases from vessel top & naphtha, heavier components from bottom. The bottom product from separator may go through series of columns-stripper, debutanizer, naphtha splitter to separate C3, C4, C3-C4 mix and different naphtha cuts products. The lighter off gases (C3-) are sent back to gas con section & ultimately to fuel gas header. Fractionation unit 46 may thus have one or more effluents 70.

In the foregoing specification, the invention has been described with reference to specific embodiments thereof. However, the specification is to be regarded in an illustrative rather than a restrictive sense. For example, compressors, reactors, membranes, exchangers, furnaces, units, other equipment, process streams, processes, reactants, catalysts, products, and operating conditions falling within the claimed or disclosed parameters, but not specifically identified or tried in a particular example, are expected to be within the scope of this invention.

The present invention may be practiced in the absence of an element not disclosed. In addition, the present invention may suitably comprise, consist or consist essentially of the elements disclosed. For instance, there may be provided a Fluid Catalytic Cracker (FCC) unit comprising, consisting essentially of, or consisting of, a wet gas compressor (WGC) comprising suction, a C3-C4/naphtha fractionation unit, and a gas plant section comprising an effluent feeding a fuel gas system, where the FCC unit is characterized by, in parallel to the WGC, an auxiliary compressor comprising a FCC slip stream from the WGC suction, and a membrane system receiving compressed FCC wet gas from the auxiliary compressor, where the membrane system comprises, consists essentially of, or consists of, a separated relatively lighter hydrocarbon component effluent stream in fluid communication with the C3-C4/naphtha fractionation unit, and a separated relatively heavier hydrocarbon component effluent stream in fluid communication with an untreated fuel gas system.

There may be additionally provided a method for operating a Fluid Catalytic Cracker (FCC) unit in petrochemical mode, where the method comprises, consists essentially of, or consists of feeding dry gas and LPG from a FCC fractionator to a wet gas compressor (WGC); withdrawing a slip stream from the feed to the WGC and supplying it to an auxiliary compressor and membrane separation system, which auxiliary compressor and membrane separation system is parallel to the WGC; compressing the slip stream in the auxiliary compressor to produce a compressed stream; feeding the compressed stream to a membrane system comprising a membrane; separating the compressed stream into a relatively lighter hydrocarbon component effluent stream and a relatively heavier hydrocarbon component effluent stream; transporting the relatively lighter hydrocarbon component effluent stream to a C3-C4/naphtha fractionation unit; and transporting the relatively heavier hydrocarbon component effluent stream to an untreated fuel gas system which in turn feeds a treatment section.

The words “comprising” and “comprises” as used throughout the claims, are to be interpreted to mean “including but not limited to” and “includes but not limited to”, respectively.

As used herein, the word “substantially” shall mean “being largely but not wholly that which is specified.”

As used herein, the singular forms “a,” “an,” and “the” are intended to include the plural forms as well, unless the context clearly indicates otherwise.

As used herein, the term “about” in reference to a given parameter is inclusive of the stated value and has the meaning dictated by the context (e.g., it includes the degree of error associated with measurement of the given parameter).

As used herein, the term “and/or” includes any and all combinations of one or more of the associated listed items.

1. A Fluid Catalytic Cracker (FCC) unit comprising:
a wet gas compressor (WGC) comprising suction;
a C3-C4/naphtha fractionation unit; and
a gas plant section comprising an effluent feeding
a fuel gas system;
characterized by, in parallel to the WGC:
an auxiliary compressor comprising a FCC slip stream from the WGC suction; and
a membrane system receiving compressed FCC wet gas from the auxiliary compressor, the membrane system comprising:
a separated relatively lighter hydrocarbon component effluent stream in fluid communication with the C3-C4/naphtha fractionation unit; and
a separated relatively heavier hydrocarbon component effluent stream in fluid communication with an untreated fuel gas system.

2. The FCC unit of claim 1 where the FCC slip stream is at least 10 vol % of the WGC suction.

3. The FCC unit of claim 1 where the separated relatively lighter hydrocarbon component comprises C3, C4, and naphtha.

4. The FCC unit of claim 1 where the separated relatively lighter hydrocarbon component effluent stream is in subsequent fluid communication with a debutanizer.

5. The FCC unit of claim 1 further comprising an FCC reactor operating in petrochemical mode generating additional C3-C4 and naphtha as compared to the FCC reactor operating in gasoline/diesel maximization mode, and where the FCC unit has an absence of a parallel gas plant.

6. A method for operating a Fluid Catalytic Cracker (FCC) unit in petrochemical mode, the method comprising:
feeding dry gas and LPG from a FCC fractionator to a wet gas compressor (WGC);
withdrawing a slip stream from the feed to the WGC and supplying it to an auxiliary compressor and membrane separation system, which auxiliary compressor and membrane separation system is parallel to the WGC;
compressing the slip stream in the auxiliary compressor to produce a compressed stream;
feeding the compressed stream to a membrane system comprising a membrane;
separating the compressed stream into a relatively lighter hydrocarbon component effluent stream and a relatively heavier hydrocarbon component effluent stream via the membrane;
transporting the relatively lighter hydrocarbon component effluent stream to a C3-C4/naphtha fractionation unit; and
transporting the relatively heavier hydrocarbon component effluent stream to an untreated fuel gas system which in turn feeds a treatment section.

7. The method of claim 6 where the FCC slip stream is at least 10 vol % of the feed to the WGC.

8. The method of claim 6 where the separated relatively lighter hydrocarbon component comprises C3, C4, and naphtha.

9. The method of claim 6 where the separated relatively lighter hydrocarbon component effluent stream is fed to a debutanizer.

10. The method of claim 6 further comprising operating an FCC reactor that generates additional C3-C4 and naphtha from the FCC fractionator in petrochemical mode as compared to operating the FCC reactor in gasoline/diesel maximization mode, and where the FCC unit has an absence of a parallel gas plant.
